(19) United States
(12) Patent Application Publication
(10) Pub. No.: US 2026/0163680 A1
(43) Pub. Date: Jun. 11, 2026

(54) HYBRID AUTOMATIC REPEAT REQUEST FEEDBACK BASED ON BIT TRANSITION QUANTITY THRESHOLD

(71) Applicant: QUALCOMM Incorporated, San Diego, CA (US)

(72) Inventors: Mostafa KHOSHNEVISAN, San Diego, CA (US); Junyi LI, Greentown, PA (US); Jing SUN, San Diego, CA (US); Jing JIANG, San Diego, CA (US)

(21) Appl. No.: 18/972,044

(22) Filed: Dec. 6, 2024

(51) Int. Cl. H04L 1/1822; H04L 5/00

(52) U.S. Cl. CPC H04L 1/1822; H04L 5/0055

(57) ABSTRACT

Various aspects of the present disclosure generally relate to wireless communication. Some aspects more specifically relate to a lossy compression scheme for correlated hybrid automatic repeat request acknowledgment (HARQ-ACK) that depends on a HARQ-ACK codebook size and a quantity of bit transitions within HARQ-ACK bits. A user equipment (UE) may identify a maximum quantity of bit transitions, identify a set of HARQ-ACK codewords using the maximum quantity of bit transitions, and select a HARQ-ACK codeword from among the HARQ-ACK codewords that has a fewest quantity of differences in bit value from the HARQ-ACK bits. The UE may transmit, to a network node, an indication of an index of the selected HARQ-ACK codeword, and the network node may interpret the HARQ-ACK codeword as HARQ-ACK feedback.

### FIELD OF THE DISCLOSURE

Aspects of the present disclosure generally relate to wireless communication and specifically relate to techniques, apparatuses, and methods associated with communication of hybrid automatic repeat request feedback in accordance with a bit transmission quantity threshold.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

A user equipment (UE) may transmit hybrid automatic repeat request acknowledgments (HARQ-ACKs) to trigger a network node to perform a retransmission if the UE detects an error with an initial transmission. In some examples, a UE may implement a compression scheme that reduces a quantity of transmitted HARQ-ACK bits. However, such compression schemes may not account for a quantity of bit transitions from a 0-bit to a 1-bit and/or bit transitions from a 1-bit to a 0-bit within the HARQ-ACK bits, which can limit the effectiveness of such compression schemes. As a result, in certain examples, compression schemes that do not account for the quantity of bit transitions within the HARQ-ACK bits may offer little compression gain.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive one or more downlink communications. At least one processor of the one or more processors may be configured to cause the UE to transmit, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit one or more downlink communications. At least one processor of the one or more processors may be configured to cause the network node to receive, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to a method of wireless communication performed at a UE. The method may include receiving one or more downlink communications. The method may include transmitting, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to a method of wireless communication performed at a network node. The method may include transmitting one or more downlink communications. The method may include receiving, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to an apparatus for wireless communication. The apparatus may include means for receiving one or more downlink communications. The apparatus may include means for transmitting, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to an apparatus for wireless communication. The apparatus may include means for transmitting one or more downlink communications. The apparatus may include means for receiving, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to a non-transitory computer-readable medium storing a set of instructions for wireless communication. The set of instructions may include one or more instructions that, when executed at a UE, cause the UE to receive one or more downlink communications. The set of instructions may include one or more instructions that, when executed at the UE, cause the UE to transmit, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Some aspects described herein relate to a non-transitory computer-readable medium storing a set of instructions for wireless communication. The set of instructions may include one or more instructions that, when executed at a network node, cause the network node to transmit one or more downlink communications. The set of instructions may include one or more instructions that, when executed at the network node, cause the network node to receive, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example associated with signaling for hybrid automatic repeat request (HARQ) feedback using a bit transmission quantity threshold, in accordance with the present disclosure.

FIG. 3 is a diagram illustrating an example associated with encoding and decoding of HARQ feedback using a bit transmission quantity threshold, in accordance with the present disclosure.

FIG. 4 is a diagram illustrating an example associated with various sets of codewords, in accordance with the present disclosure.

FIG. 5 is a flowchart illustrating an example process performed, for example, at a user equipment (UE) or an apparatus of a UE that supports communication of HARQ feedback using a bit transmission quantity threshold, in accordance with the present disclosure.

FIG. 6 is a flowchart illustrating an example process performed, for example, at a network node or an apparatus of a network node that communication of HARQ feedback using a bit transmission quantity threshold, in accordance with the present disclosure.

FIG. 7 is a diagram of an example apparatus for wireless communication, such as a UE, that supports communication of HARQ feedback using a bit transmission quantity threshold, in accordance with the present disclosure.

FIG. 8 is a diagram of an example apparatus for wireless communication, such as a network node, that supports communication of HARQ feedback using a bit transmission quantity threshold, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Hybrid automatic repeat request (HARQ) is part of a retransmission protocol. The receiver of a transmission (such as a user equipment (UE) receiving a downlink transmission) may check for errors in received data and, if an error is detected, may buffer the received data and request a retransmission from a transmitter of the transmission (such as a network node transmitting the downlink transmission). For example, downlink data may be transmitted on a physical downlink shared channel (PDSCH), and HARQ acknowledgments (ACKs) may be returned on either a physical uplink control channel (PUCCH) or a physical uplink shared channel (PUSCH). The receiver can then combine the buffered data with the retransmitted data prior to channel decoding and error detection, which improves the performance of retransmission.

HARQ feedback regarding a communication may be provided in accordance with a HARQ-ACK codebook (referred to herein as a HARQ codebook). A HARQ codebook defines a format used to signal a set of HARQ-ACK bits to the network node. If the UE transmits HARQ feedback using a format defined by a given HARQ codebook, the UE may be said to transmit the given HARQ codebook. HARQ-ACK codebooks have non-uniform distributions of bits because positive acknowledgments are more likely than negative acknowledgements (NACKs). For example, in an open loop link adaptation that maintains a downlink block error rate (BLER) at 10%, the probability of a given bit being a positive acknowledgment (for example, a “1”) is 0.9, and the probability of a given bit being a NACK (for example, a “0”) is 0.1. This non-uniform probability improves the compressibility of HARQ-ACK codebooks.

Moreover, due to channel and/or interference correlation among different PDSCH communications received at different times, frequencies, and/or spatial layers, HARQ-ACK bits may be correlated, which may further improve the compressibility of HARQ-ACK codebooks. Any compression of HARQ-ACK bits should avoid NACK-to-ACK errors where possible because the cost of a NACK-to-ACK error-which may prevent HARQ combining for PDSCHs—may be greater than the cost of an ACK-to-NACK error (which may merely result in unnecessary PDSCH retransmissions).

HARQ-ACK bits may be correlated sources, meaning that consecutive positive acknowledgments (for example, ACKs or 1-bits) or consecutive negative acknowledgments (for example, NACKs or 0-bits) can occur frequently within a data set of the HARQ-ACK bits. In correlated and non-uniform sources, such as where the probability of a 1-bit (ACK) is much greater than the probability of a 0-bit (NACK), the most common events can be a quantity of consecutive 1-bits, and a less frequent event can be a quantity of consecutive 0-bits; however, transitions from a 0-bit to a 1-bit or transitions from a 1-bit to a 0-bit can be rare in the data set. In correlated HARQ-ACK, the probability of a given quantity of bit transitions occurring depends on a pre-compression HARQ-ACK codebook size. Without accounting for the quantity of bit transitions, a lossy compression scheme for HARQ-ACK may provide only limited compression gain in certain examples.

Various aspects relate generally to a generalized and parametric lossy compression scheme. Some aspects more specifically relate to a lossy compression scheme for correlated HARQ-ACK that depends on a HARQ-ACK codebook size and a quantity of bit transitions within HARQ-ACK bits. The lossy compression scheme may avoid NACK-to-ACK errors and minimize ACK-to-NACK errors, and may not be a function of a probability distribution of the HARQ-ACK bits (although a performance of the lossy compression scheme may be a function of the probability distribution). In some aspects, a UE may identify a maximum quantity of bit transitions. For example, the UE may identify the maximum quantity of bit transitions using the HARQ-ACK codebook size, a nominal compression ratio, a maximum quantity of compressed bits, or an explicit indication of the maximum quantity of bit transitions received from a network node, among other examples. In some aspects, the UE may identify a set of HARQ-ACK codewords using the maximum quantity of bit transitions. In some aspects, the UE may select a HARQ-ACK codeword, from among the HARQ-ACK codewords, that has a fewest quantity of differences in bit value from the HARQ-ACK bits. The UE may transmit, to the network node, an indication of an index of the selected HARQ-ACK codeword. The network node may interpret the HARQ-ACK codeword as HARQ-ACK feedback.

In some aspects, the UE may identify whether to include, in the set of HARQ-ACK codewords, both candidate HARQ-ACK codewords with the maximum quantity of bit transitions that start with a positive acknowledgment bit and candidate HARQ-ACK codewords with the maximum quantity of bit transitions that start with a negative acknowledgment bit, or only the candidate HARQ-ACK codewords with the maximum quantity of bit transitions that start with a positive acknowledgment bit. This operation may provide additional granularity in examples where the maximum quantity of bit transitions is an even number, because if the maximum quantity of bit transitions is an even number, then HARQ-ACK codewords with the maximum quantity of bit transitions that start with a positive acknowledgment bit are more likely than HARQ-ACK codewords with the maximum quantity of bit transitions that start with a negative acknowledgment bit.

In some aspects, the UE may include, in the set of HARQ-ACK codewords, additional HARQ-ACK codewords such that a total quantity of HARQ-ACK codewords in the set of HARQ-ACK codewords is equal to two to a power of a quantity of compressed HARQ-ACK bits. In some examples, the additional HARQ-ACK codewords may include HARQ-ACK codewords having respective quantities of bit transitions that are greater than the maximum quantity of bit transitions. In some examples, the additional HARQ-ACK codewords may include HARQ-ACK codewords having respective quantities of bit transitions that are equal to the maximum quantity of bit transitions and starting with a negative acknowledgment bit.

Particular aspects of the subject matter described in this disclosure can be implemented to realize one or more of the following potential advantages. In some examples, the lossy compression scheme can be used to increase compression gains. For example, the lossy compression scheme may provide a compression ratio of

$$k / ( 1 + ⌈ {log}_{2} {\sum }_{i = 0}^{m} ( \begin{matrix}k - 1 \\ i\end{matrix} ) ⌉ ) ,$$

where k is the HARQ-ACK codebook size and m is the maximum quantity of bit transitions.

The additional granularity provided in examples where the maximum quantity of bit transitions is an even number may help to reduce a total quantity of HARQ-ACK codewords and, thus, reduce processing resource allocated for selecting the HARQ-ACK codeword from among the HARQ-ACK codewords.

Increasing the total quantity of HARQ-ACK codewords in the set of HARQ-ACK codewords to two to the power of the quantity of compressed HARQ-ACK bits may increase a quantity of HARQ-ACK codewords from which the UE can select the HARQ-ACK codeword and, thus, further improve compression gains.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

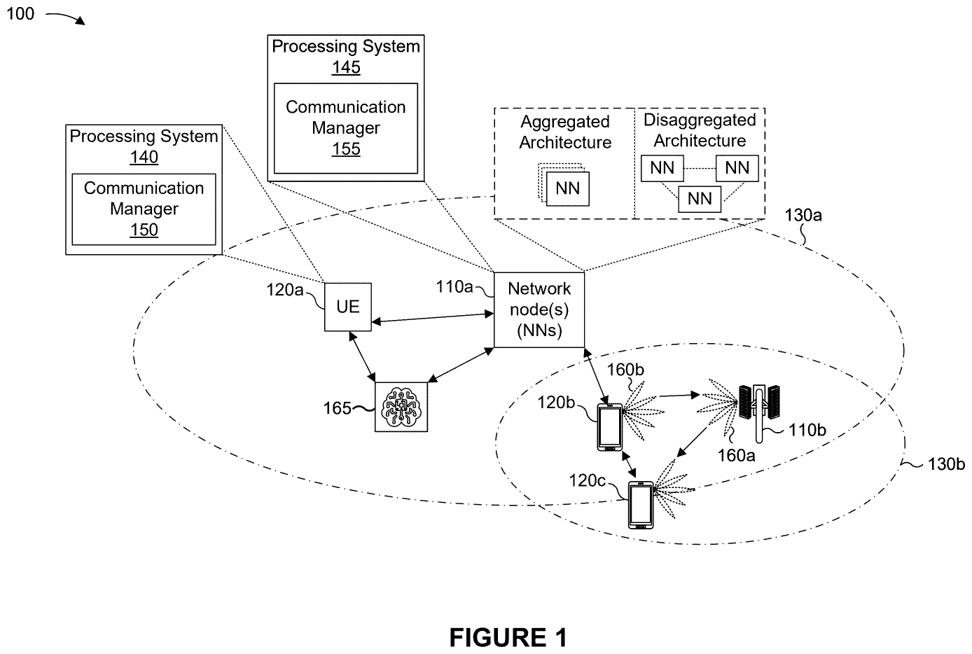

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities are to be used to collect measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the UE 120 may include a communication manager 150. As described in more detail elsewhere herein, the communication manager 150 may receive one or more downlink communications; and transmit, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. Additionally or alternatively, the communication manager 150 may perform one or more other operations described herein.

In some aspects, the network node 110 may include a communication manager 155. As described in more detail elsewhere herein, the communication manager 155 may transmit one or more downlink communications; and receive, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. Additionally or alternatively, the communication manager 155 may perform one or more other operations described herein.

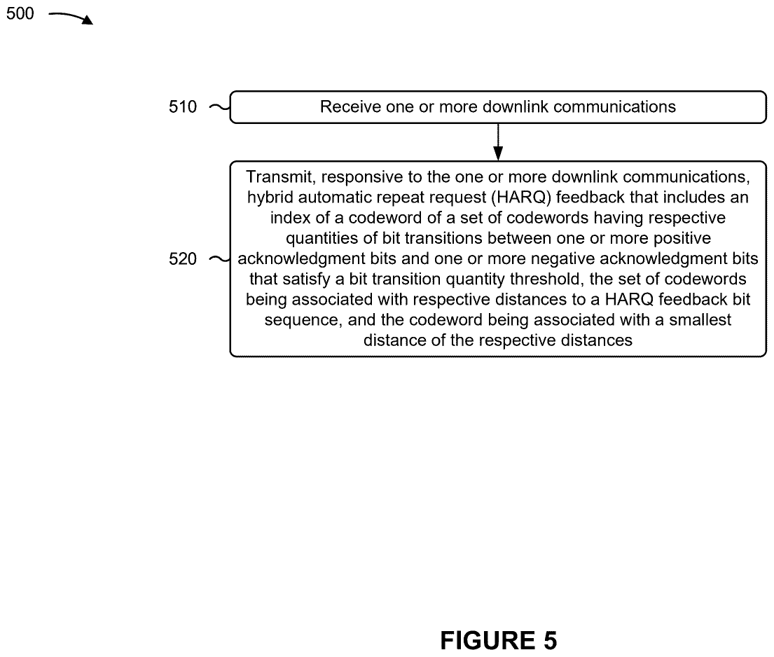

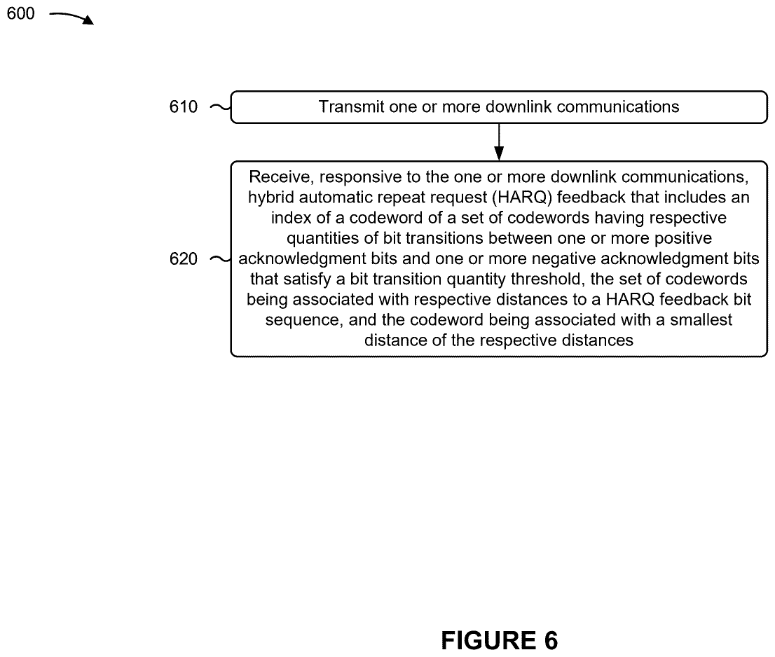

The network node 110, the processing system 145 of the network node 110, the UE 120, the processing system 140 of the UE 120, a CU, a DU, an RU, or any other component(s) of FIG. 1 may implement one or more techniques or perform one or more operations associated with communication of HARQ feedback in accordance with a bit transmission quantity threshold, as described in more detail elsewhere herein. For example, the processing system 145 of the network node 110, the processing system 140 of the UE 120, a CU, a DU, and/or an RU may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU, the DU, or the RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, a CU, a DU, and/or an RU, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

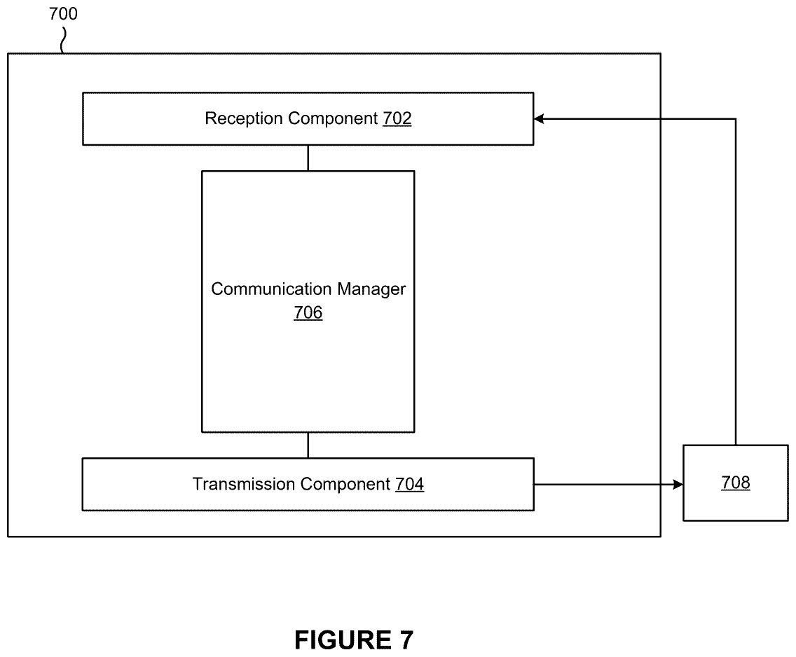

In some aspects, the UE 120 includes means for receiving one or more downlink communications; and/or means for transmitting, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

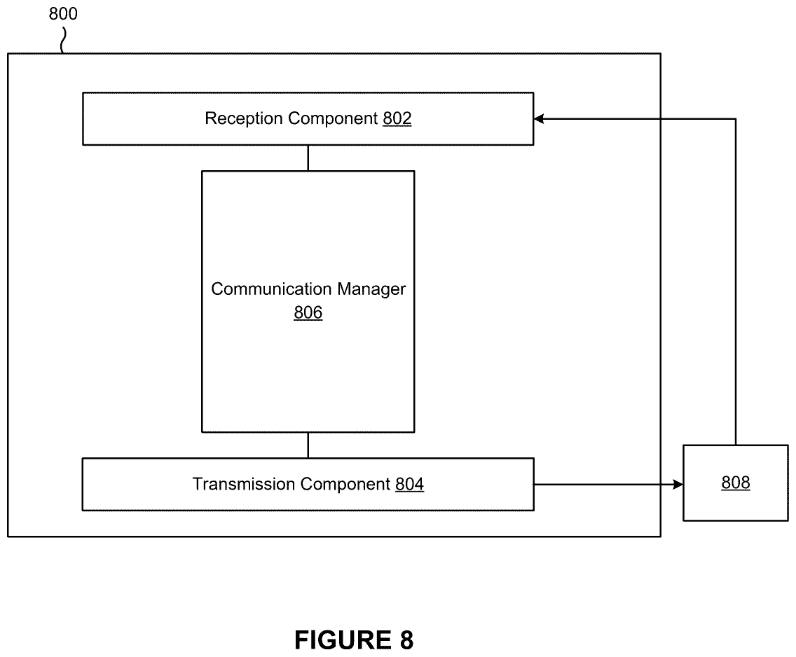

In some aspects, the network node 110 includes means for transmitting one or more downlink communications; and/or means for receiving, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

HARQ-ACK bits may be correlated sources, meaning that consecutive positive acknowledgments (for example, ACKs or 1-bits) or consecutive negative acknowledgments (for example, NACKs or 0-bits) can occur frequently within a data set of the HARQ-ACK bits. In correlated and non-uniform sources, such as where the probability of a 1-bit (ACK) is much greater than the probability of a 0-bit (NACK), the most common events can be a quantity of consecutive 1-bits, and a less frequent event can be a quantity of consecutive 0-bits; however, transitions from a 0-bit to a 1-bit or transitions from a 1-bit to a 0-bit can be rare in the data set. In correlated HARQ-ACK, the probability of a given quantity of bit transitions occurring depends on the pre-compression HARQ-ACK codebook size k. Without accounting for the quantity of bit transitions, a lossy compression scheme for HARQ-ACK may provide only limited compression gain in certain examples.

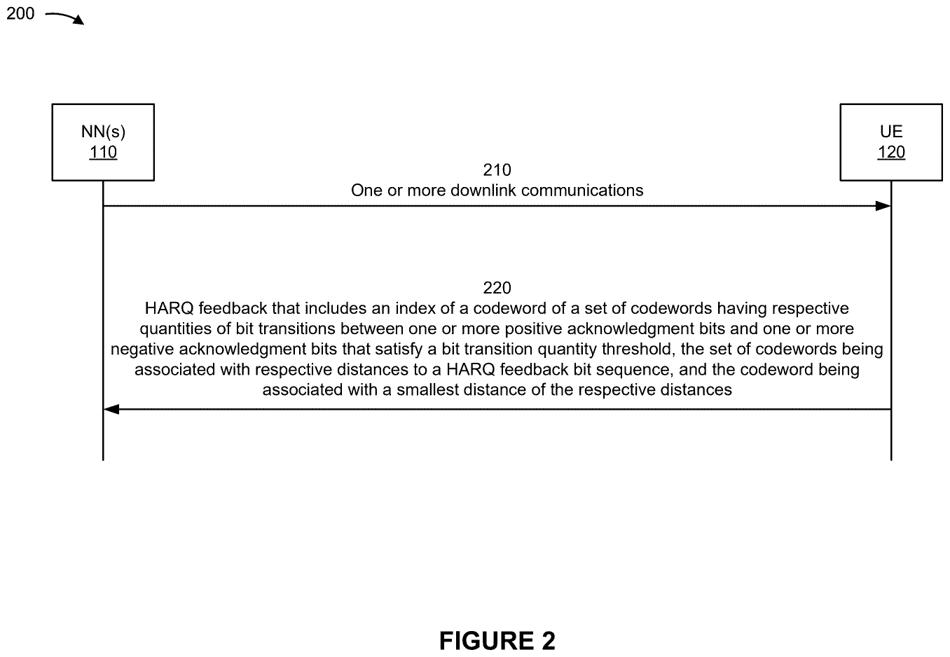

FIG. 2 is a diagram illustrating an example 200 associated with signaling for HARQ feedback using a bit transmission quantity threshold, in accordance with the present disclosure. As shown in FIG. 2, a network node 110 and a UE 120 may communicate with one another.

In a first operation 210, the network node 110 may transmit, and the UE 120 may receive, one or more downlink communications. For example, the one or more downlink communications may be carried via a single PDSCH or multiple PDSCHs. In some examples, the UE 120 may generate and/or identify a HARQ feedback bit sequence corresponding to the one or more downlink communications. The HARQ feedback bit sequence may be a bit sequence of a pre-compression HARQ-ACK codebook. For example, bits of the HARQ feedback bit sequence may correspond to the single PDSCH (for example, to different codebooks or codebook groups of the PDSCH) or to the multiple PDSCHs. The HARQ feedback bit sequence may include one or more positive acknowledgment bits and/or one or more negative acknowledgment bits. A positive acknowledgment bit may indicate that the UE 120 successfully decoded certain data conveyed by the one or more downlink communications, and a negative acknowledgment bit may indicate that the UE 120 did not decode certain data conveyed by the one or more downlink communications. For example, a positive acknowledgment bit may have a value of “1,” and a negative acknowledgment bit may have a value of “0.” The terms “ACK” or “HARQ ACK” may be used to refer to only positive acknowledgment bits, or to both positive acknowledgment bits and negative acknowledgment bits. The terms “NACK” or a “NACK bit” may be used to refer to a negative acknowledgment bit.

In a second operation 220, the UE 120 may transmit, and the network node 110 may receive, HARQ feedback responsive to the one or more downlink communications. In some aspects, the HARQ feedback may include an index of a codeword of a set of codewords. For example, the set of codewords may belong to a codebook and may have a length k bits. In some examples, k may be referred to as a codebook size, such as a size of an original (pre-compressed) HARQ-ACK codebook. In some aspects, the codewords may have respective quantities of bit transitions between one or more positive acknowledgment bits and one or more negative acknowledgment bits that satisfy a bit transition quantity threshold m. The bit transition quantity threshold may be a maximum quantity of bit transitions. For example, the codewords may include quantities of bit transitions that are between 0 and m. The bit transitions may include 0-to-1 bit transitions and/or 1-to-0 bit transitions. In some aspects, the set of codewords may be associated with respective distances to a HARQ feedback bit sequence. A distance to the HARQ feedback bit sequence may be a quantity of bit locations in which a bit value differs between the codeword and the HARQ feedback bit sequence. A codeword may be associated with a distance to the HARQ feedback bit sequence in that the codeword and the HARQ feedback bit sequence may be separated by the distance. In some aspects, the codeword may be associated with a smallest distance of the respective distances. For example, the codeword that the HARQ feedback includes the index of may be separated from the HARQ feedback bit sequence by a smaller distance than any other codewords in the set of codewords.

In some aspects, the bit transition quantity threshold may be associated with a length of the HARQ feedback bit sequence. The bit transition quantity threshold may be associated with the length of the HARQ feedback bit sequence in that bit transition quantity threshold may depend on the length of the HARQ feedback bit sequence. For example, the value of m may be identified in accordance with the value of k. The bit transition quantity threshold may be associated with a length of the HARQ feedback bit sequence because, probabilistically, larger sizes of the HARQ feedback bit sequence may correlate with larger values of m.

In some aspects, the bit transition quantity threshold may be associated with the length of the HARQ feedback bit sequence by a mapping table. For example, the mapping table may associate (for example, correlate) the bit transition quantity threshold and the length of the HARQ feedback bit sequence. For example, the UE 120 may, given the length of the HARQ feedback bit sequence, perform a lookup in the mapping table to identify the corresponding value of m.

In some aspects, the mapping table may associate one or more ranges of HARQ feedback bit sequence lengths with respective bit transition quantity thresholds. The one or more ranges may include respective upper and lower k thresholds. For example, the UE 120 may, given k, identify a range of HARQ feedback bit sequence lengths that includes k and, using the mapping table, identify the corresponding value of m. Table 1 below illustrates an example mapping table that associates ranges of k (as defined by thresholds k₀, . . . , k₃) with respective bit transition quantity thresholds (m₁, . . . , m₄). As shown, one of the ranges for small values of k (k≤k₀) may be mapped to an indication not to use the compression scheme described in accordance with FIG. 2.

TABLE 1

| Range of HARQ feedback bit sequence length k | m |
|---|---|
| k ≤ k₀ | N/A |
| k₀ < k ≤ k₁ | m₁ |
| k₁ < k ≤ k₂ | m₂ |
| k₂ < k ≤ k₃ | m₃ |
| k₃ < k | m₄ |

In some aspects, the mapping table may be associated with a memory. The mapping table may be associated with the memory in that the memory may store the mapping table as fixed in a wireless communication standard. The memory may store one or more values of the mapping table, such as the bit transition quantity threshold, the length of the HARQ feedback bit sequence, the one or more ranges of HARQ feedback bit sequence lengths, or the respective bit transition quantity thresholds, among other examples.

In some aspects, the network node 110 may transmit, and the UE 120 may receive, an indication of the mapping table. The indication of the mapping table may include one or more values of the mapping table, such as the bit transition quantity threshold, the length of the HARQ feedback bit sequence, the one or more ranges of HARQ feedback bit sequence lengths, or the respective bit transition quantity thresholds, among other examples. In some examples, the indication of the mapping table may be an RRC configuration. In some examples, the indication of the mapping table may be carried via a MAC-CE.

In some aspects, the bit transition quantity threshold may be associated with a nominal compression ratio. The bit transition quantity threshold may be associated with the nominal compression ratio in that bit transition quantity threshold may depend on the nominal compression ratio. For example, the value of m may be identified in accordance with the nominal compression ratio r. For example, given a value of k and a value of r, the UE 120 may identify a value of m such that the actual compression ratio approximates r. Because

$$k / {k}^{′} = r = \frac{k}{1 + ⌈ {log}_{2} {\sum }_{i = 0}^{m} ( \begin{matrix}k - 1 \\ i\end{matrix} ) ⌉}$$

(where k′ is a compressed HARQ-ACK feedback length),

$$⌈ {log}_{2} {\sum }_{i = 0}^{m} ( \begin{matrix}k - 1 \\ i\end{matrix} ) ⌉ = \frac{k - r}{r} ;$$

thus, in some examples, the UE 120 may identify a largest m such that

$$⌈ {log}_{2} {\sum }_{i = 0}^{m} ( \begin{matrix}k - 1 \\ i\end{matrix} ) ⌉ \leq \frac{k - r}{r} ;$$

or a smallest m such that

$$⌈ {log}_{2} {\sum }_{i = 0}^{m} ( \begin{matrix}k - 1 \\ i\end{matrix} ) ⌉ \geq \frac{k - r}{r} .$$

In some aspects, the network node 110 may transmit, and the UE 120 may receive, an indication of the nominal compression ratio. For example, the indication of the nominal compression ratio may indicate a value of r. In some examples, the indication of the nominal compression ratio may be an RRC configuration. In some examples, the indication of the nominal compression ratio may be carried via a MAC-CE or DCI.

In some aspects, the indication of the nominal compression ratio may be an indication of a mapping table that associates one or more ranges of HARQ feedback bit sequence lengths with respective nominal compression ratios. For example, the mapping table may associate (for example, correlate) one or more ranges of HARQ feedback bit sequence lengths and respective nominal compression ratios. The one or more ranges may include respective upper and lower k thresholds. For example, the UE 120 may, given k, identify a range of HARQ feedback bit sequence lengths that includes k and, using the mapping table, identify the corresponding value of r. In some examples, the network node 110 may transmit, and the UE 120 may receive, an indication of the mapping table. The indication of the mapping table may include one or more values of the mapping table, such as the one or more ranges of HARQ feedback bit sequence lengths or the respective nominal compression ratios, among other examples. In some examples, the indication of the mapping table may be an RRC configuration. Thus, the network node 110 may indicate different values of the nominal compression ratio r for respective values of k. Table 2 below illustrates an example mapping table that associates ranges of k (as defined by thresholds k₀, . . . , k₃) with respective bit transition quantity thresholds (r₁, . . . , r₄). As shown, one of the ranges for small values of k (k≤k₀) may be mapped to an indication not to use the compression scheme described in accordance with FIG. 2.

TABLE 2

| Range of HARQ feedback bit sequence length k | r |
|---|---|
| k ≤ k₀ | N/A |
| k₀ < k ≤ k₁ | r₁ |
| k₁ < k ≤ k₂ | r₂ |
| k₂ < k ≤ k₃ | r₃ |
| k₃ < k | r₄ |

In some aspects, the bit transition quantity threshold may be associated with a compressed bit quantity threshold. The bit transition quantity threshold may be associated with the compressed bit quantity threshold in that bit transition quantity threshold may depend on the compressed bit quantity threshold. The compressed bit quantity threshold may be a maximum quantity of compressed bits (for example, a maximum quantity of bits after compression), which may be referred to as compressed HARQ-ACK feedback length k′. For example, the UE 120 may identify the value of m in accordance with the compressed HARQ-ACK feedback length k′. For example, given a value of k and a value of k′, the UE 120 may identify a value of m such that the quantity of compressed bits is less than or equal to the compressed bit quantity threshold. For example, the UE 120 may identify a largest value of m such that

$$1 + ⌈ {log}_{2} {\sum }_{i = 0}^{m} ( \begin{matrix}k - 1 \\ i\end{matrix} ) ⌉ \leq {k}^{′} .$$

As a result, compressed HARQ-ACK feedback k′ may not be exceeded regardless of the value of k (such as in examples where an uplink signal-to-interference-plus-noise ratio (SINR) dictates a coverage range of a PUCCH and, hence, the value of k′).

In some aspects, the network node 110 may transmit, and the UE 120 may receive, an indication of the compressed bit quantity threshold. For example, the indication of the compressed bit quantity threshold may indicate a value of k′. In some examples, the indication of the compressed bit quantity threshold may be an RRC configuration. In some examples, the indication of the compressed bit quantity threshold may be carried via a MAC-CE or DCI.

In some aspects, the indication of the compressed bit quantity threshold may be an indication of a mapping table that associates one or more ranges of HARQ feedback bit sequence lengths with respective compressed bit quantity thresholds. For example, the mapping table may associate (for example, correlate) one or more ranges of HARQ feedback bit sequence lengths and respective compressed bit quantity thresholds. The one or more ranges may include respective upper and lower k thresholds. For example, the UE 120 may, given k, identify a range of HARQ feedback bit sequence lengths that includes k and, using the mapping table, identify the corresponding value of k′. In some examples, the network node 110 may transmit, and the UE 120 may receive, an indication of the mapping table. The indication of the mapping table may include one or more values of the mapping table, such as the one or more ranges of HARQ feedback bit sequence lengths or the respective compressed bit quantity thresholds, among other examples. In some examples, the indication of the mapping table may be an RRC configuration. Thus, the network node 110 may indicate different values of the compressed HARQ-ACK feedback k′ for respective values of k. Table 3 below illustrates an example mapping table that associates ranges of k (as defined by thresholds k₀, . . . , k₃) with respective compressed bit quantity thresholds (k′1, . . . , k′₄). As shown, one of the ranges for small values of k (k≤k₀) may be mapped to an indication not to use the compression scheme described in accordance with FIG. 2.

TABLE 3

| Range of HARQ feedback bit sequence length k | k′ |
|---|---|
| k ≤ k₀ | N/A |
| k₀ < k ≤ k₁ | k′₁ |
| k₁ < k ≤ k₂ | k′₂ |
| k₂ < k ≤ k₃ | k′₃ |
| k₃ < k | k′₄ |

In some aspects, the network node 110 may transmit, and the UE 120 may receive, an indication of the bit transition quantity threshold. For example, the indication of the bit transition quantity threshold may indicate a value of m. From the perspective of the network node 110, the indicated value of m may be a function of k, r, k′, or uplink SINR, among other examples; however, the value of m being a function of other variables may be transparent to UE 120 (for example, the UE 120 may not be informed whether or how the value of m is a function of other variables). In some examples, the indication of the compressed bit quantity threshold may be an RRC configuration. In some examples, the indication of the compressed bit quantity threshold may be carried via a MAC-CE or DCI.

In some aspects, the indication of the bit transition quantity threshold is a final DCI communication of a plurality of DCI communications associated with the HARQ feedback. The plurality of DCI communications may be associated with the HARQ feedback in that the plurality of DCI communications schedule the HARQ feedback (for example, the plurality of DCI communications may point to the same slot for the HARQ feedback). For example, if the UE 120 receives the plurality of DCI communications, the UE 120 may follow the indication of the bit transition quantity threshold in the final DCI communication (for example, the last DCI communication among the plurality of DCI communications).

In some aspects, the network node 110 may transmit, and the UE 120 may receive, an indication of a set of candidate bit transition quantity thresholds. For example, the indication of a set of candidate bit transition quantity thresholds may be configured via RRC signaling or MAC-CE. The set of candidate bit transition quantity thresholds may be a set of candidate values of m. The bit transition quantity threshold may be a selected one of the candidate bit transition quantity thresholds. For example, DCI may indicate a selected value of m. For example, if the set of candidate bit transition quantity thresholds is {2,3}, then one bit of the DCI may indicate a selected value of m (for example, a bit value of 0 may indicate 2, and a bit value of 1 may indicate 3).

In some aspects, the bit transition quantity threshold may be an even number, and all codewords of the set of codewords having respective quantities of bit transitions that equal the bit transition quantity threshold may start with a positive acknowledgment bit. In examples where the value of m is even, a codeword with m transitions starting with a positive acknowledgment bit (for example, 1) is more likely than a codeword with m transitions starting with negative acknowledgment bit (for example, 0). However, this difference in likelihoods does not hold for odd values of m. This different in likelihoods may hold for even values of m due to non-uniform probabilities of 1's and 0's (for example, the probability of 1 may be much greater than the probability of 0), and because when m is an even number, a codeword that starts with 1, ends with 1. Thus, upon identifying the value of m (for example, where m is an even number), the UE 120 may also identify whether all codewords with m transitions or only the codewords with m transitions that start with a positive acknowledgment are included in the set of codewords. As a result, an additional granularity may be provided for even values of m by distinguishing between codewords that start with 1 and codewords that start with 0. In some examples, this additional granularity may be implemented for i=m transitions and not for i<m transitions (including for even values of i), where i is a quantity of transitions in a codeword in the set of codewords, because codewords having values of i that are less than the maximum value of i (for example, m) are more likely than codewords having the maximum value of i. In some examples, the UE 120 may identify whether all codewords with m transitions or only the codewords with m transitions that start with a positive acknowledgment are included in the set of codewords in accordance with k, r, k′, or an explicit indication received from the network node 110, among other examples. If only the codewords with m transitions that start with a positive acknowledgment are included in the set of codewords, then the quantity of codewords may be

$$( \begin{matrix}k - 1 \\ m\end{matrix} ) + {\sum }_{i = 0}^{m - 1} 2 ( \begin{matrix}k - 1 \\ i\end{matrix} ) ; hence , {k}^{′} = ⌈ {log}_{2} ( ( \begin{matrix}k - 1 \\ m\end{matrix} ) + {\sum }_{i = 0}^{m - 1} 2 ( \begin{matrix}k - 1 \\ i\end{matrix} ) ) ⌉ .$$

This computation of k′ may be used in other aspects described herein if the identification of whether only the codewords with m transitions that start with a positive acknowledgment are included in the set of codewords, and/or the identification of m, depend on a nominal compression ratio r or the value of k′.

In some aspects, a total quantity of codewords of the set of codewords may be equal to two to a power of a compressed bit quantity threshold (for example, 2^{k′}). For example, if a quantity of codewords with up to m transitions is not be a power of two, then the UE 120 may add one or more codewords to the set of codewords until the total quantity of codewords in the set becomes equal to 2^{k′}. For example, the UE 120 may add the one or more codewords after identifying m and, hence, k′.

In some aspects, the set of codewords may include one or more codewords having respective quantities of bit transitions that do not satisfy the bit transition quantity threshold. For example, the UE 120 may add one or more codewords having m+1 transitions. The one or more codewords may be a subset of all codewords having m+1 transitions. The inclusion of the one or more codewords in the set of codewords may result in the same quantity of bits after compression (for example, k′), and hence, may not impact feedback overhead; however, such inclusion may decrease loss associated with lossy compression. The set of codewords may include one or more codewords having respective quantities of bit transitions that do not satisfy the bit transition quantity threshold in examples where the additional granularity described above is not employed, where m is odd, or where the additional granularity described above is employed and results in all codewords with m transitions being included in the set of codewords.

In some aspects, the set of codewords may include one or more codewords having respective quantities of bit transitions that equal the bit transition quantity threshold and starting with respective negative acknowledgment bits. For example, the UE 120 may add one or more codewords that are a subset of codewords with m transitions and have a starting bit of 0. The set of codewords may include one or more codewords having respective quantities of bit transitions that equal the bit transition quantity threshold and starting with respective negative acknowledgment bits in examples where the additional granularity described above is employed, m is even, and results in only codewords with m transitions and that have a starting bit of 1 being included in the set of codewords.

In some aspects, the set of codewords may include one or more codewords in accordance with an ordering of the one or more codewords. For example, the ordering of the one or more codewords may control which of a set of candidate codewords is added to the set of codewords. For example, the one or more codewords that are added to the set of codewords may be a subset of the candidate codewords. The candidate codewords may be all codewords with m+1 transitions (in examples where the set of codewords may include one or more codewords having respective quantities of bit transitions that do not satisfy the bit transition quantity threshold) or all codewords with m transitions and having a starting bit of 0 (in examples where the set of codewords may include one or more codewords having respective quantities of bit transitions that equal the bit transition quantity threshold and starting with respective negative acknowledgment bits).

In some aspects, the ordering may be associated with one or more integer representations of one or more binary sequences of the one or more codewords. The ordering may be associated with one or more integer representations in that the ordering may depend on the one or more integer representations. For example, the ordering may prioritize codewords having larger integers. For example, the UE 120 may select a codeword having a binary sequence of 11101110 (corresponding to an integer representation of 238) before a codeword having a binary sequence of 11101100 (with integer representation of 236). In this example, both codewords have the same quantity of transitions (3).

In some aspects, the ordering may be associated with one or more quantities of positive acknowledgment bits of the one or more codewords. The ordering may be associated with one or more quantities of positive acknowledgment bits in that the ordering may depend on the one or more quantities of positive acknowledgment bits. For example, the ordering may prioritize codewords having larger quantities of positive acknowledgment bits. In some examples, if two or more codewords have the same quantity of positive acknowledgment bits, then the two or more codewords may be prioritized using the ordering associated with integer representations of binary sequences of the two or more codewords, as described above.

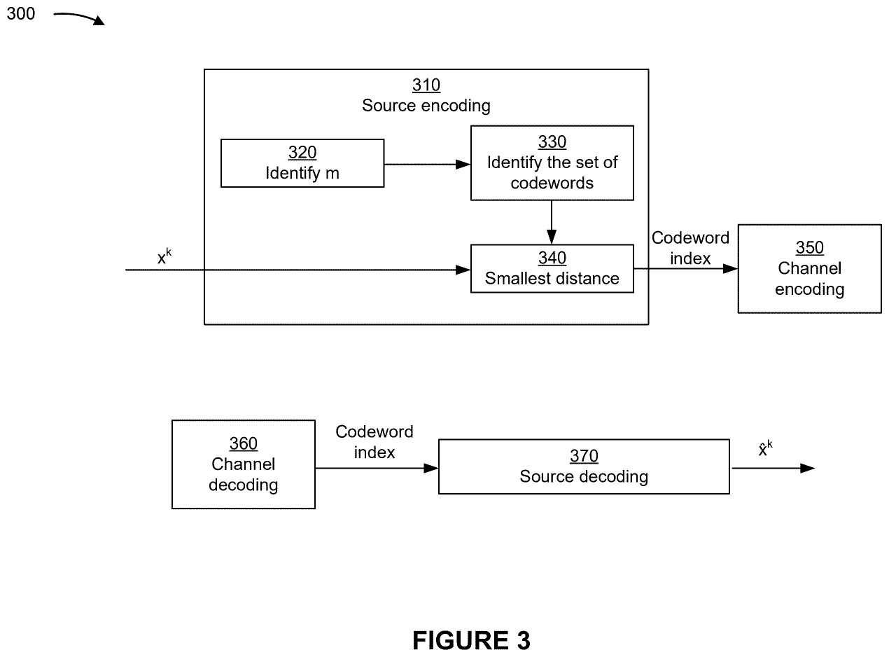

FIG. 3 is a diagram illustrating an example 300 associated with encoding and decoding of HARQ feedback using a bit transmission quantity threshold, in accordance with the present disclosure.

In a first operation 310, the UE 120 may perform source encoding on the HARQ feedback bit sequence (for example, an original HARQ-ACK sequence of length k, denoted by x^{k}). For example, the UE 120 may perform source encoding (for example, compression) for k HARQ-ACK bits. The source encoding may involve one or more operations. For example, in a second operation 320, the UE 120 may identify the value of m (the maximum quantity of transitions). In a third operation 330, the UE 120 may identity the set of codewords of length k in accordance with the value of m. For example, the UE 120 may consider all codewords of length k that have m or fewer transitions. In some examples, if there is a negative acknowledgment bit in the i′th location (1≤i≤k) of the sequence x^{k}, then the UE 120 may not consider a codeword with a positive acknowledgment in the same i′th location. This approach may remove all codewords that would result in a NACK-to-ACK error. In a fourth operation 340, the UE 120 may identify a codeword, from among the set of codewords, that has the smallest distance to x^{k}, where a “distance” is a quantity of bit locations in which x^{k} and the codeword differ. In some examples, only codewords that would result in ACK-to-NACK errors may be selected as having the smallest distance, which may avoid NACK-to-ACK errors and reduce (for example minimize) ACK-to-NACK errors. The UE 120 may identify an index of the codeword with the smallest distance. If multiple codewords have the same smallest distance, then the UE 120 may select the codeword having the smallest index. In a fifth operation 350, the UE 120 may perform channel encoding on an index of the codeword. The UE 120 may transmit the index of the codeword as the HARQ feedback. In a sixth operation 360, the network node 110 may perform channel decoding for the group having the codeword index. In a seventh operation 370, the network node 110 may perform source decoding (for example, decompression) by decoding the HARQ feedback as the codeword corresponding to the index.

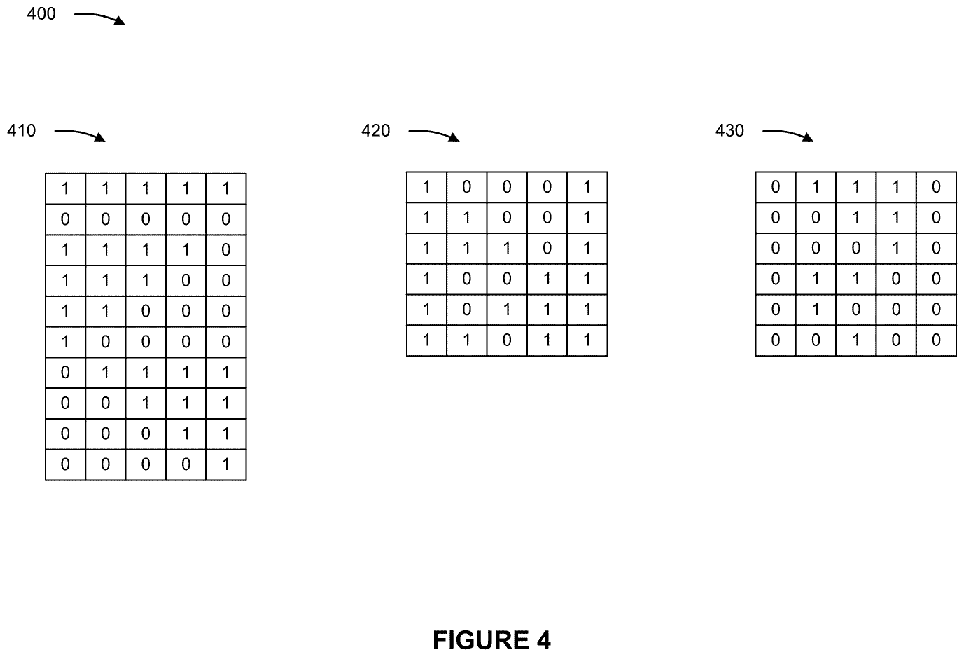

FIG. 4 is a diagram illustrating an example 400 associated with various sets of codewords, in accordance with the present disclosure.

In some examples, the set of codewords may include a first codeword that starts with a positive acknowledgment bit, ends with a positive acknowledgment bit, and includes no bit transitions between one or more positive acknowledgment bits and one or more negative acknowledgment bits. For example, the first codeword may include all positive acknowledgment bits (for example, all 1-bits). In some examples, the set of codewords may include a second codeword that starts with a negative acknowledgment bit, ends with a negative acknowledgment bit, and includes no bit transitions between one or more positive acknowledgment bits and one or more negative acknowledgment bits. For example, the second codeword may include all negative acknowledgment bits (for example, all 0-bits). In some examples, the set of codewords may include third codewords that start with a positive acknowledgment bit, end with a negative acknowledgment bit, and include a single bit transition between one or more positive acknowledgment bits and one or more negative acknowledgment bits. For example, the third codewords may start with a 1-bit, end with a 0-bit, and have only one transition between the 1-bit and the 0-bit. In some examples, the set of codewords may include fourth codewords that start with a negative acknowledgment bit, end with a positive acknowledgment bit, and include a single bit transition between one or more positive acknowledgment bits and one or more negative acknowledgment bits. For example, the fourth codewords may start with a 0-bit, end with a 1-bit, and have only one transition between the 0-bit and the 1-bit. In some examples, the set of codewords may include fifth codewords that start with a positive acknowledgment bit, end with a positive acknowledgment bit, and include two bit transitions between one or more positive acknowledgment bits and one or more negative acknowledgment bits. For example, the fifth codewords may start with a 1-bit, end with a 1-bit, and have two transitions between the 1-bits. In some examples, the set of codewords may include sixth codewords that start with a negative acknowledgment bit, end with a negative acknowledgment bit, and include two bit transitions between one or more positive acknowledgment bits and one or more negative acknowledgment bits. For example, the sixth codewords may start with a 0-bit, end with a 0-bit, and have two transitions between the 0-bits.

In first aspects, the set of codewords may include the first codeword, the second codeword, the third codewords, and the fourth codewords. In second aspects, the set of codewords may include the first codeword, the second codeword, the third codewords, the fourth codewords, and the fifth codewords. In third aspects, the set of codewords may include the first codeword, the second codeword, the third codewords, the fourth codewords, and the sixth codewords. In fourth aspects, the set of codewords may include the first codeword, the second codeword, the third codewords, the fourth codewords, the fifth codewords, and the sixth codewords.

Example 400 (where k=5) shows a first set of codewords 410, a second set of codewords 420, and a third set of codewords 430. The set of codewords of the first aspects may include the first set of codewords 410. The set of codewords of the second aspects may include the first set of codewords 410 and the second set of codewords 420. The set of codewords of the third aspects may include the first set of codewords 410 and the third set of codewords 430. The set of codewords of the fourth aspects may include the first set of codewords 410, the second set of codewords 420, and the third set of codewords 430.

Transmitting the HARQ feedback that includes the index of the codeword of the set of codewords having respective quantities of bit transitions that satisfy the bit transition quantity threshold, the set of codewords being associated with respective distances to a HARQ feedback bit sequence, and the codeword being associated with a smallest distance of the respective distances, may help to increase compression gains. For example, the compression ratio may be

$$k / {k}^{′} = k / ( 1 + ⌈ {log}_{2} {\sum }_{i = 0}^{m} ( \begin{matrix}k - 1 \\ i\end{matrix} ) ⌉ ) .$$

For example, the quantity of codewords with exactly i transitions is

$$2 ( \begin{matrix}k - 1 \\ i\end{matrix} ) because ( \begin{matrix}k - 1 \\ i\end{matrix} )$$

codewords with i transitions start with 1, and

$$( \begin{matrix}k - 1 \\ i\end{matrix} )$$

codwords with i transitions start with 0; hence, the quantity of codewords having up to m transitions

$${\sum }_{i = 0}^{m} 2 ( \begin{matrix}k - 1 \\ i\end{matrix} ) ,$$

and the quantity of bits after compression (to indicate the codeword index) is

$${k}^{′} = ⌈ {log}_{2} ( {\sum }_{i = 0}^{m} 2 ( \begin{matrix}k - 1 \\ i\end{matrix} ) ) ⌉ = 1 + ⌈ {log}_{2} {\sum }_{i = 0}^{m} ( \begin{matrix}k - 1 \\ i\end{matrix} ) ⌉ .$$

Table 4 below provides an example where k=20 and m=3. In this example, the total quantity of codewords is 2320, k′=12, and the compression ratio is 20/12.

TABLE 4

| Quantity of | | Quantity of |
|---|---|---|
| transitions | Codewords | codewords |
| i = 0 | 1 ... 1, | 2 |
| | 0 ... 0 | |
| i = 1 | 1 ... 10, 1 ... 100, ... , 10 ... 0 0 ... 01, 0 .. . 011, ... , 01 ... 1 | $2 ( \begin{matrix}19 \\ 1\end{matrix} ) = 38$ |
| i = 2 | 1 ... 101, 1 ... 1011, ... , 10 ... 01 0 ... 010, 0 ... 0100, ... , 01 ... 10 | $2 ( \begin{matrix}19 \\ 2\end{matrix} ) = 342$ |
| i = 3 | 1 ... 1010, 1 ... 10100, ... , 1010 ... 0 0 ... 0101, 0 ... 01011, ... , 0101 ... 1 | $2 ( \begin{matrix}19 \\ 3\end{matrix} ) = 1938$ |

The bit transition quantity threshold being an even number, and all codewords of the set of codewords having respective quantities of bit transitions that equal the bit transition quantity threshold starting with a positive acknowledgment bit, may help to reduce a total quantity of codewords and, thus, reduce processing resource allocated for selecting the codeword from among the codewords.

The total quantity of codewords of the set of codewords being equal to two to a power of a compressed bit quantity threshold may increase a quantity of codewords from which the UE 120 can select the codeword and, thus, further improve compression gains.

FIG. 5 is a flowchart illustrating an example process 500 performed, for example, at a UE or an apparatus of a UE that supports communication of HARQ feedback using a bit transmission quantity threshold, in accordance with the present disclosure. Example process 500 is an example where the apparatus or the UE (for example, UE 120) performs operations associated with communication of HARQ feedback using a bit transmission quantity threshold.

As shown in FIG. 5, in some aspects, process 500 may include receiving one or more downlink communications (block 510). For example, the UE (such as by using communication manager 150 or reception component 702, depicted in FIG. 7) may receive one or more downlink communications, as described above.

As further shown in FIG. 5, in some aspects, process 500 may include transmitting, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances (block 520). For example, the UE (such as by using communication manager 150 or transmission component 704, depicted in FIG. 7) may transmit, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances, as described above.

Process 500 may include additional aspects, such as any single aspect or any combination of aspects described below or in connection with one or more other processes described elsewhere herein.

In a first additional aspect, the bit transition quantity threshold is associated with a length of the HARQ feedback bit sequence.

In a second additional aspect, alone or in combination with the first aspect, the bit transition quantity threshold is associated with the length of the HARQ feedback bit sequence by a mapping table.

In a third additional aspect, alone or in combination with one or more of the first and second aspects, the mapping table associates one or more ranges of HARQ feedback bit sequence lengths with respective bit transition quantity thresholds.

In a fourth additional aspect, alone or in combination with one or more of the first through third aspects, the mapping table is associated with a memory.

In a fifth additional aspect, alone or in combination with one or more of the first through fourth aspects, process 500 includes receiving an indication of the mapping table.

In a sixth additional aspect, alone or in combination with one or more of the first through fifth aspects, the bit transition quantity threshold is associated with a nominal compression ratio.

In a seventh additional aspect, alone or in combination with one or more of the first through sixth aspects, process 500 includes receiving an indication of the nominal compression ratio.

In an eighth additional aspect, alone or in combination with one or more of the first through seventh aspects, the indication of the nominal compression ratio is an indication of a mapping table that associates one or more ranges of HARQ feedback bit sequence lengths with respective nominal compression ratios.

In a ninth additional aspect, alone or in combination with one or more of the first through eighth aspects, the bit transition quantity threshold is associated with a compressed bit quantity threshold.

In a tenth additional aspect, alone or in combination with one or more of the first through ninth aspects, process 500 includes receiving an indication of the compressed bit quantity threshold.

In an eleventh additional aspect, alone or in combination with one or more of the first through tenth aspects, the indication of the compressed bit quantity threshold is an indication of a mapping table that associates one or more ranges of HARQ feedback bit sequence lengths with respective compressed bit quantity thresholds.

In a twelfth additional aspect, alone or in combination with one or more of the first through eleventh aspects, process 500 includes receiving an indication of the bit transition quantity threshold.

In a thirteenth additional aspect, alone or in combination with one or more of the first through twelfth aspects, the indication of the bit transition quantity threshold is a final DCI communication of a plurality of DCI communications associated with the HARQ feedback.

In a fourteenth additional aspect, alone or in combination with one or more of the first through thirteenth aspects, process 500 includes receiving an indication of a set of candidate bit transition quantity thresholds, and the bit transition quantity threshold is a selected one of the candidate bit transition quantity thresholds.

In a fifteenth additional aspect, alone or in combination with one or more of the first through fourteenth aspects, the bit transition quantity threshold is an even number, and all codewords of the set of codewords having respective quantities of bit transitions that equal the bit transition quantity threshold start with a positive acknowledgment bit.

In a sixteenth additional aspect, alone or in combination with one or more of the first through fifteenth aspects, a total quantity of codewords of the set of codewords is equal to two to a power of a compressed bit quantity threshold.

In a seventeenth additional aspect, alone or in combination with one or more of the first through sixteenth aspects, the set of codewords includes one or more codewords having respective quantities of bit transitions that do not satisfy the bit transition quantity threshold.

In an eighteenth additional aspect, alone or in combination with one or more of the first through seventeenth aspects, the set of codewords includes one or more codewords having respective quantities of bit transitions that equal the bit transition quantity threshold and starting with respective negative acknowledgment bits.

In a nineteenth additional aspect, alone or in combination with one or more of the first through eighteenth aspects, the set of codewords includes one or more codewords in accordance with an ordering of the one or more codewords.

In a twentieth additional aspect, alone or in combination with one or more of the first through nineteenth aspects, the ordering is associated with one or more integer representations of one or more binary sequences of the one or more codewords.

In a twenty-first additional aspect, alone or in combination with one or more of the first through twentieth aspects, the ordering is associated with one or more quantities of positive acknowledgment bits of the one or more codewords.

In a twenty-second additional aspect, alone or in combination with one or more of the first through twenty-first aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, and fourth codewords that start with a negative acknowledgment bit, end with a positive acknowledgment bit, and include a single bit transition between one or more positive acknowledgment bits and one or more negative acknowledgment bits.

In a twenty-third additional aspect, alone or in combination with one or more of the first through twenty-second aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a positive acknowledgment bit, end with a positive acknowledgment bit, and include two bit transitions between one or more positive acknowledgment bits and one or more negative acknowledgment bits.

In a twenty-fourth additional aspect, alone or in combination with one or more of the first through twenty-third aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a negative acknowledgment bit, end with a negative acknowledgment bit, and include two bit transitions between one or more positive acknowledgment bits and one or more negative acknowledgment bits.

In a twenty-fifth additional aspect, alone or in combination with one or more of the first through twenty-fourth aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that starts with a negative acknowledgment bit, ends with a positive acknowledgment bit, and includes a single bit transition between one or more positive acknowledgment bits and one or more negative acknowledgment bits, fifth codewords that start with a positive acknowledgment bit, end with a positive acknowledgment bit, and include two bit transitions between one or more positive acknowledgment bits and one or more negative acknowledgment bits, and sixth codewords that start with a negative acknowledgment bit, end with a negative acknowledgment bit, and include two bit transitions between one or more positive acknowledgment bits and one or more negative acknowledgment bits.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that communication of HARQ feedback using a bit transmission quantity threshold, in accordance with the present disclosure. Example process 600 is an example where the apparatus or the network node (for example, network node 110) performs operations associated with communication of HARQ feedback using a bit transmission quantity threshold.

As shown in FIG. 6, in some aspects, process 600 may include transmitting one or more downlink communications (block 610). For example, the network node (such as by using communication manager 150 or transmission component 804, depicted in FIG. 8) may transmit one or more downlink communications, as described above.

As further shown in FIG. 6, in some aspects, process 600 may include receiving, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances (block 620). For example, the network node (such as by using communication manager 150 or reception component 802, depicted in FIG. 8) may receive, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances, as described above.

Process 600 may include additional aspects, such as any single aspect or any combination of aspects described below or in connection with one or more other processes described elsewhere herein.

In a first additional aspect, the bit transition quantity threshold is associated with a length of the HARQ feedback bit sequence.

In a second additional aspect, alone or in combination with the first aspect, the bit transition quantity threshold is associated with the length of the HARQ feedback bit sequence by a mapping table.

In a third additional aspect, alone or in combination with one or more of the first and second aspects, the mapping table associates one or more ranges of HARQ feedback bit sequence lengths with respective bit transition quantity thresholds.

In a fourth additional aspect, alone or in combination with one or more of the first through third aspects, the mapping table is associated with a memory.

In a fifth additional aspect, alone or in combination with one or more of the first through fourth aspects, process 600 includes transmitting an indication of the mapping table.

In a sixth additional aspect, alone or in combination with one or more of the first through fifth aspects, the bit transition quantity threshold is associated with a nominal compression ratio.

In a seventh additional aspect, alone or in combination with one or more of the first through sixth aspects, process 600 includes transmitting an indication of the nominal compression ratio.

In an eighth additional aspect, alone or in combination with one or more of the first through seventh aspects, the indication of the nominal compression ratio is an indication of a mapping table that associates one or more ranges of HARQ feedback bit sequence lengths with respective nominal compression ratios.

In a ninth additional aspect, alone or in combination with one or more of the first through eighth aspects, the bit transition quantity threshold is associated with a compressed bit quantity threshold.

In a tenth additional aspect, alone or in combination with one or more of the first through ninth aspects, process 600 includes transmitting an indication of the compressed bit quantity threshold.

In an eleventh additional aspect, alone or in combination with one or more of the first through tenth aspects, the indication of the compressed bit quantity threshold is an indication of a mapping table that associates one or more ranges of HARQ feedback bit sequence lengths with respective compressed bit quantity thresholds.

In a twelfth additional aspect, alone or in combination with one or more of the first through eleventh aspects, process 600 includes transmitting an indication of the bit transition quantity threshold.

In a thirteenth additional aspect, alone or in combination with one or more of the first through twelfth aspects, the indication of the bit transition quantity threshold is a final DCI communication of a plurality of DCI communications associated with the HARQ feedback.

In a fourteenth additional aspect, alone or in combination with one or more of the first through thirteenth aspects, process 600 includes transmitting an indication of a set of candidate bit transition quantity thresholds, and the bit transition quantity threshold is a selected one of the candidate bit transition quantity thresholds.

In a fifteenth additional aspect, alone or in combination with one or more of the first through fourteenth aspects, the bit transition quantity threshold is an even number, and all codewords of the set of codewords having respective quantities of bit transitions that equal the bit transition quantity threshold start with a positive acknowledgment bit.

In a sixteenth additional aspect, alone or in combination with one or more of the first through fifteenth aspects, a total quantity of codewords of the set of codewords is equal to two to a power of a compressed bit quantity threshold.

In a seventeenth additional aspect, alone or in combination with one or more of the first through sixteenth aspects, the set of codewords includes one or more codewords having respective quantities of bit transitions that do not satisfy the bit transition quantity threshold.

In an eighteenth additional aspect, alone or in combination with one or more of the first through seventeenth aspects, the set of codewords includes one or more codewords having respective quantities of bit transitions that equal the bit transition quantity threshold and starting with respective negative acknowledgment bits.

In a nineteenth additional aspect, alone or in combination with one or more of the first through eighteenth aspects, the set of codewords includes one or more codewords in accordance with an ordering of the one or more codewords.

In a twentieth additional aspect, alone or in combination with one or more of the first through nineteenth aspects, the ordering is associated with one or more integer representations of one or more binary sequences of the one or more codewords.

In a twenty-first additional aspect, alone or in combination with one or more of the first through twentieth aspects, the ordering is associated with one or more quantities of positive acknowledgment bits of the one or more codewords.

In a twenty-second additional aspect, alone or in combination with one or more of the first through twenty-first aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, and fourth codewords that start with a negative acknowledgment bit, end with a positive acknowledgment bit, and include a single bit transition between one or more positive acknowledgment bits and one or more negative acknowledgment bits.

In a twenty-third additional aspect, alone or in combination with one or more of the first through twenty-second aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a positive acknowledgment bit, end with a positive acknowledgment bit, and include two bit transitions between one or more positive acknowledgment bits and one or more negative acknowledgment bits.

In a twenty-fourth additional aspect, alone or in combination with one or more of the first through twenty-third aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a negative acknowledgment bit, end with a negative acknowledgment bit, and include two bit transitions between one or more positive acknowledgment bits and one or more negative acknowledgment bits.

In a twenty-fifth additional aspect, alone or in combination with one or more of the first through twenty-fourth aspects, the set of codewords includes a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that starts with a negative acknowledgment bit, ends with a positive acknowledgment bit, and includes a single bit transition between one or more positive acknowledgment bits and one or more negative acknowledgment bits, fifth codewords that start with a positive acknowledgment bit, end with a positive acknowledgment bit, and include two bit transitions between one or more positive acknowledgment bits and one or more negative acknowledgment bits, and sixth codewords that start with a negative acknowledgment bit, end with a negative acknowledgment bit, and include two bit transitions between one or more positive acknowledgment bits and one or more negative acknowledgment bits.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports communication of HARQ feedback using a bit transmission quantity threshold, in accordance with the present disclosure. The apparatus 700 may be a UE, or a UE may include the apparatus 700. In some aspects, the apparatus 700 includes a reception component 702, a transmission component 704, and a communication manager 706, which may be in communication with one another (for example, via one or more buses). As shown, the apparatus 700 may communicate with another apparatus 708 (such as a UE 120, a network node 110, or another wireless communication device) using the reception component 702 and the transmission component 704. The communication manager 706 may be included in, or implemented via, a processing system (for example, the processing system 140). In some aspects, the communication manager 706 is the communication manager 150.

In some aspects, the apparatus 700 may be configured to and/or operable to perform one or more operations described herein in connection with FIGS. 2-4. Additionally or alternatively, the apparatus 700 may be configured to and/or operable to perform one or more processes described herein, such as process 500 of FIG. 5.

The reception component 702 may receive communications, such as reference signals, control information, and/or data communications, from the apparatus 708. The reception component 702 may provide received communications to one or more other components of the apparatus 700, such as the communication manager 706. In some aspects, the reception component 702 may perform signal processing on the received communications, and may provide the processed signals to the one or more other components in a similar manner as described above in connection with FIG. 1. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, and/or data communications, to the apparatus 708. In some aspects, the communication manager 706 may generate communications and may transmit the generated communications to the transmission component 704 for transmission to the apparatus 708. In some aspects, the transmission component 704 may perform signal processing on the generated communications, and may transmit the processed signals to the apparatus 708 in a similar manner as described above in connection with FIG. 1. In some aspects, the transmission component 704 may include one or more components of the UE described above in connection with FIG. 1, such as a radio, one or more RF chains, one or more transceivers, or one or more modems, each of which may in turn be coupled with one or more antennas of the UE. In some aspects, the transmission component 704 may be co-located with the reception component 702.

The communication manager 706 may receive or may cause the reception component 702 to receive one or more downlink communications. The communication manager 706 may transmit or may cause the transmission component 704 to transmit, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. In some aspects, the communication manager 706 may perform one or more operations described elsewhere herein as being performed by one or more components of the communication manager 706.

The reception component 702 may receive one or more downlink communications. The transmission component 704 may transmit, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. In some aspects, the reception component 702 may receive an indication of the mapping table. In some aspects, the reception component 702 may receive an indication of the nominal compression ratio. In some aspects, the reception component 702 may receive an indication of the compressed bit quantity threshold. In some aspects, the reception component 702 may receive an indication of the bit transition quantity threshold. In some aspects, the reception component 702 may receive an indication of a set of candidate bit transition quantity thresholds, wherein the bit transition quantity threshold is a selected one of the candidate bit transition quantity thresholds.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports communication of HARQ feedback using a bit transmission quantity threshold, in accordance with the present disclosure. The apparatus 800 may be a network node, or a network node may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 145). In some aspects, the communication manager 806 is the communication manager 155.

In some aspects, the apparatus 800 may be configured to and/or operable to perform one or more operations described herein in connection with FIGS. 2-4. Additionally or alternatively, the apparatus 800 may be configured to and/or operable to perform one or more processes described herein, such as process 600 of FIG. 6.

The reception component 802 may receive communications, such as reference signals, control information, and/or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the network node described above in connection with FIG. 1, such as a radio, one or more RF chains, one or more transceivers, or one or more modems, each of which may in turn be coupled with one or more antennas of the network node.

The transmission component 804 may transmit communications, such as reference signals, control information, and/or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the network node described above in connection with FIG. 1, such as a radio, one or more RF chains, one or more transceivers, or one or more modems, each of which may in turn be coupled with one or more antennas of the network node. In some aspects, the transmission component 804 may be co-located with the reception component 802.

The communication manager 806 may transmit or may cause the transmission component 804 to transmit one or more downlink communications. The communication manager 806 may receive or may cause the reception component 802 to receive, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. In some aspects, the communication manager 806 may perform one or more operations described elsewhere herein as being performed by one or more components of the communication manager 806.

The transmission component 804 may transmit one or more downlink communications. The reception component 802 may receive, responsive to the one or more downlink communications, HARQ feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances. In some aspects, the transmission component 804 may transmit an indication of the mapping table. In some aspects, the transmission component 804 may transmit an indication of the nominal compression ratio. In some aspects, the transmission component 804 may transmit an indication of the compressed bit quantity threshold. In some aspects, the transmission component 804 may transmit an indication of the bit transition quantity threshold. In some aspects, the transmission component 804 may transmit an indication of a set of candidate bit transition quantity thresholds, wherein the bit transition quantity threshold is a selected one of the candidate bit transition quantity thresholds.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed at a user equipment (UE), comprising: receiving one or more downlink communications; and transmitting, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.
Aspect 2: The method of Aspect 1, wherein the bit transition quantity threshold is associated with a length of the HARQ feedback bit sequence.
Aspect 3: The method of Aspect 2, wherein the bit transition quantity threshold is associated with the length of the HARQ feedback bit sequence by a mapping table.
Aspect 4: The method of Aspect 3, wherein the mapping table associates one or more ranges of HARQ feedback bit sequence lengths with respective bit transition quantity thresholds.
Aspect 5: The method of Aspect 3, wherein the mapping table is associated with a memory.
Aspect 6: The method of Aspect 3, further comprising: receiving an indication of the mapping table.
Aspect 7: The method of any of Aspects 1-6, wherein the bit transition quantity threshold is associated with a nominal compression ratio.
Aspect 8: The method of Aspect 7, further comprising: receiving an indication of the nominal compression ratio.
Aspect 9: The method of Aspect 8, wherein the indication of the nominal compression ratio is an indication of a mapping table that associates one or more ranges of HARQ feedback bit sequence lengths with respective nominal compression ratios.
Aspect 10: The method of any of Aspects 1-9, wherein the bit transition quantity threshold is associated with a compressed bit quantity threshold.
Aspect 11: The method of Aspect 10, further comprising: receiving an indication of the compressed bit quantity threshold.
Aspect 12: The method of Aspect 11, wherein the indication of the compressed bit quantity threshold is an indication of a mapping table that associates one or more ranges of HARQ feedback bit sequence lengths with respective compressed bit quantity thresholds.
Aspect 13: The method of any of Aspects 1-12, further comprising: receiving an indication of the bit transition quantity threshold.
Aspect 14: The method of Aspect 13, wherein the indication of the bit transition quantity threshold is a final downlink control information (DCI) communication of a plurality of DCI communications associated with the HARQ feedback.
Aspect 15: The method of Aspect 13, further comprising: receiving an indication of a set of candidate bit transition quantity thresholds, wherein the bit transition quantity threshold is a selected one of the candidate bit transition quantity thresholds.
Aspect 16: The method of any of Aspects 1-15, wherein the bit transition quantity threshold is an even number, and wherein all codewords of the set of codewords having respective quantities of bit transitions that equal the bit transition quantity threshold start with a positive acknowledgment bit.
Aspect 17: The method of any of Aspects 1-16, wherein a total quantity of codewords of the set of codewords is equal to two to a power of a compressed bit quantity threshold.
Aspect 18: The method of Aspect 17, wherein the set of codewords includes one or more codewords having respective quantities of bit transitions that do not satisfy the bit transition quantity threshold.
Aspect 19: The method of Aspect 17, wherein the set of codewords includes one or more codewords having respective quantities of bit transitions that equal the bit transition quantity threshold and starting with respective negative acknowledgment bits.
Aspect 20: The method of Aspect 17, wherein the set of codewords includes one or more codewords in accordance with an ordering of the one or more codewords.
Aspect 21: The method of Aspect 20, wherein the ordering is associated with one or more integer representations of one or more binary sequences of the one or more codewords.
Aspect 22: The method of Aspect 20, wherein the ordering is associated with one or more quantities of positive acknowledgment bits of the one or more codewords.
Aspect 23: The method of any of Aspects 1-22, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, and fourth codewords that start with a negative acknowledgment bit, end with a positive acknowledgment bit, and include a single bit transition between one or more positive acknowledgment bits and one or more negative acknowledgment bits.
Aspect 24: The method of any of Aspects 1-23, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a positive acknowledgment bit, end with a positive acknowledgment bit, and include two bit transitions between one or more positive acknowledgment bits and one or more negative acknowledgment bits.
Aspect 25: The method of any of Aspects 1-24, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a negative acknowledgment bit, end with a negative acknowledgment bit, and include two bit transitions between one or more positive acknowledgment bits and one or more negative acknowledgment bits.
Aspect 26: The method of any of Aspects 1-25, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that starts with a negative acknowledgment bit, ends with a positive acknowledgment bit, and includes a single bit transition between one or more positive acknowledgment bits and one or more negative acknowledgment bits, fifth codewords that start with a positive acknowledgment bit, end with a positive acknowledgment bit, and include two bit transitions between one or more positive acknowledgment bits and one or more negative acknowledgment bits, and sixth codewords that start with a negative acknowledgment bit, end with a negative acknowledgment bit, and include two bit transitions between one or more positive acknowledgment bits and one or more negative acknowledgment bits.
Aspect 27: A method of wireless communication performed by a network node, comprising: transmitting one or more downlink communications; and receiving, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.
Aspect 28: The method of Aspect 27, wherein the bit transition quantity threshold is associated with a length of the HARQ feedback bit sequence.
Aspect 29: The method of Aspect 28, wherein the bit transition quantity threshold is associated with the length of the HARQ feedback bit sequence by a mapping table.
Aspect 30: The method of Aspect 29, wherein the mapping table associates one or more ranges of HARQ feedback bit sequence lengths with respective bit transition quantity thresholds.
Aspect 31: The method of Aspect 29, wherein the mapping table is associated with a memory.
Aspect 32: The method of Aspect 29, further comprising: transmitting an indication of the mapping table.
Aspect 33: The method of any of Aspects 27-32, wherein the bit transition quantity threshold is associated with a nominal compression ratio.
Aspect 34: The method of Aspect 33, further comprising: transmitting an indication of the nominal compression ratio.
Aspect 35: The method of Aspect 34, wherein the indication of the nominal compression ratio is an indication of a mapping table that associates one or more ranges of HARQ feedback bit sequence lengths with respective nominal compression ratios.
Aspect 36: The method of any of Aspects 27-35, wherein the bit transition quantity threshold is associated with a compressed bit quantity threshold.
Aspect 37: The method of Aspect 36, further comprising: transmitting an indication of the compressed bit quantity threshold.
Aspect 38: The method of Aspect 37, wherein the indication of the compressed bit quantity threshold is an indication of a mapping table that associates one or more ranges of HARQ feedback bit sequence lengths with respective compressed bit quantity thresholds.
Aspect 39: The method of any of Aspects 27-38, further comprising: transmitting an indication of the bit transition quantity threshold.
Aspect 40: The method of Aspect 39, wherein the indication of the bit transition quantity threshold is a final downlink control information (DCI) communication of a plurality of DCI communications associated with the HARQ feedback.
Aspect 41: The method of Aspect 39, further comprising: transmitting an indication of a set of candidate bit transition quantity thresholds, wherein the bit transition quantity threshold is a selected one of the candidate bit transition quantity thresholds.
Aspect 42: The method of any of Aspects 27-41, wherein the bit transition quantity threshold is an even number, and wherein all codewords of the set of codewords having respective quantities of bit transitions that equal the bit transition quantity threshold start with a positive acknowledgment bit.
Aspect 43: The method of any of Aspects 27-42, wherein a total quantity of codewords of the set of codewords is equal to two to a power of a compressed bit quantity threshold.
Aspect 44: The method of Aspect 43, wherein the set of codewords includes one or more codewords having respective quantities of bit transitions that do not satisfy the bit transition quantity threshold.
Aspect 45: The method of Aspect 43, wherein the set of codewords includes one or more codewords having respective quantities of bit transitions that equal the bit transition quantity threshold and starting with respective negative acknowledgment bits.
Aspect 46: The method of Aspect 43, wherein the set of codewords includes one or more codewords in accordance with an ordering of the one or more codewords.
Aspect 47: The method of Aspect 46, wherein the ordering is associated with one or more integer representations of one or more binary sequences of the one or more codewords.
Aspect 48: The method of Aspect 46, wherein the ordering is associated with one or more quantities of positive acknowledgment bits of the one or more codewords.
Aspect 49: The method of any of Aspects 27-48, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, and fourth codewords that start with a negative acknowledgment bit, end with a positive acknowledgment bit, and include a single bit transition between one or more positive acknowledgment bits and one or more negative acknowledgment bits.
Aspect 50: The method of any of Aspects 27-49, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a positive acknowledgment bit, end with a positive acknowledgment bit, and include two bit transitions between one or more positive acknowledgment bits and one or more negative acknowledgment bits.
Aspect 51: The method of any of Aspects 27-50, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that start with a negative acknowledgment bit, end with a positive acknowledgment bit, and include a single bit transition between one or more positive acknowledgment bits and one or more negative acknowledgment bits, and fifth codewords that start with a negative acknowledgment bit, end with a negative acknowledgment bit, and include two bit transitions between one or more positive acknowledgment bits and one or more negative acknowledgment bits.
Aspect 52: The method of any of Aspects 27-51, wherein the set of codewords includes: a first codeword that starts with a positive acknowledgment bit, ends with a positive acknowledgment bit, and includes no bit transitions between one or more positive acknowledgment bits and one or more negative acknowledgment bits, a second codeword that starts with a negative acknowledgment bit, ends with a negative acknowledgment bit, and includes no bit transitions between one or more positive acknowledgment bits and one or more negative acknowledgment bits, third codewords that start with a positive acknowledgment bit, end with a negative acknowledgment bit, and include a single bit transition between one or more positive acknowledgment bits and one or more negative acknowledgment bits, fourth codewords that starts with a negative acknowledgment bit, ends with a positive acknowledgment bit, and includes a single bit transition between one or more positive acknowledgment bits and one or more negative acknowledgment bits, fifth codewords that start with a positive acknowledgment bit, end with a positive acknowledgment bit, and include two bit transitions between one or more positive acknowledgment bits and one or more negative acknowledgment bits, and sixth codewords that start with a negative acknowledgment bit, end with a negative acknowledgment bit, and include two bit transitions between one or more positive acknowledgment bits and one or more negative acknowledgment bits.
Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.
Aspect 54: An apparatus for wireless communication at a device, the apparatus comprising one or more memories and one or more processors coupled to the one or more memories, the one or more processors configured to cause the device to perform the method of one or more of Aspects 1-52.
Aspect 55: An apparatus for wireless communication, the apparatus comprising at least one means for performing the method of one or more of Aspects 1-52.
Aspect 56: A non-transitory computer-readable medium storing code for wireless communication, the code comprising instructions executable by one or more processors to perform the method of one or more of Aspects 1-52.
Aspect 57: A non-transitory computer-readable medium storing a set of instructions for wireless communication, the set of instructions comprising one or more instructions that, when executed by one or more processors of a device, cause the device to perform the method of one or more of Aspects 1-52.
Aspect 58: A device for wireless communication, the device comprising a processing system that includes one or more processors and one or more memories coupled with the one or more processors, the processing system configured to cause the device to perform the method of one or more of Aspects 1-52.
Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive one or more downlink communications; and
transmit, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

2. The apparatus of claim 1, wherein the bit transition quantity threshold is associated with a length of the HARQ feedback bit sequence.

3. The apparatus of claim 2, wherein the bit transition quantity threshold is associated with the length of the HARQ feedback bit sequence by a mapping table.

4. The apparatus of claim 3, wherein the mapping table associates one or more ranges of HARQ feedback bit sequence lengths with respective bit transition quantity thresholds.

5. The apparatus of claim 3, wherein the mapping table is associated with a memory.

6. The apparatus of claim 3, wherein at least one processor of the one or more processors is configured to cause the UE to:
receive an indication of the mapping table.

7. The apparatus of claim 1, wherein the bit transition quantity threshold is associated with a nominal compression ratio.

8. The apparatus of claim 7, wherein at least one processor of the one or more processors is configured to cause the UE to:
receive an indication of the nominal compression ratio.

9. The apparatus of claim 8, wherein the indication of the nominal compression ratio is an indication of a mapping table that associates one or more ranges of HARQ feedback bit sequence lengths with respective nominal compression ratios.

10. The apparatus of claim 1, wherein the bit transition quantity threshold is associated with a compressed bit quantity threshold.

11. The apparatus of claim 10, wherein at least one processor of the one or more processors is configured to cause the UE to:
receive an indication of the compressed bit quantity threshold.

12. The apparatus of claim 11, wherein the indication of the compressed bit quantity threshold is an indication of a mapping table that associates one or more ranges of HARQ feedback bit sequence lengths with respective compressed bit quantity thresholds.

13. An apparatus for wireless communication at a network node, comprising:
one or more memories storing processor-executable code; and
one or more processors coupled with the one or more memories, at least one processor of the one or more processors configured to cause the network node to:
transmit one or more downlink communications; and
receive, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

14. The apparatus of claim 13, wherein at least one processor of the one or more processors is configured to cause the network node to:
transmit an indication of the bit transition quantity threshold.

15. The apparatus of claim 14, wherein the indication of the bit transition quantity threshold is a final downlink control information (DCI) communication of a plurality of DCI communications associated with the HARQ feedback.

16. The apparatus of claim 14, wherein at least one processor of the one or more processors is configured to cause the network node to:
transmit an indication of a set of candidate bit transition quantity thresholds, wherein the bit transition quantity threshold is a selected one of the candidate bit transition quantity thresholds.

17. The apparatus of claim 13, wherein the bit transition quantity threshold is an even number, and wherein all codewords of the set of codewords having respective quantities of bit transitions that equal the bit transition quantity threshold start with a positive acknowledgment bit.

18. The apparatus of claim 13, wherein a total quantity of codewords of the set of codewords is equal to two to a power of a compressed bit quantity threshold.

19. The apparatus of claim 18, wherein the set of codewords includes one or more codewords having respective quantities of bit transitions that do not satisfy the bit transition quantity threshold.

20. The apparatus of claim 18, wherein the set of codewords includes one or more codewords having respective quantities of bit transitions that equal the bit transition quantity threshold and starting with respective negative acknowledgment bits.

21. The apparatus of claim 18, wherein the set of codewords includes one or more codewords in accordance with an ordering of the one or more codewords.

22. The apparatus of claim 21, wherein the ordering is associated with one or more integer representations of one or more binary sequences of the one or more codewords.

23. The apparatus of claim 21, wherein the ordering is associated with one or more quantities of positive acknowledgment bits of the one or more codewords.

24. The apparatus of claim 1, wherein the set of codewords includes:
a first codeword that starts with a positive acknowledgment bit, ends with a positive acknowledgment bit, and includes no bit transitions between one or more positive acknowledgment bits and one or more negative acknowledgment bits,
a second codeword that starts with a negative acknowledgment bit, ends with a negative acknowledgment bit, and includes no bit transitions between one or more positive acknowledgment bits and one or more negative acknowledgment bits,
third codewords that start with a positive acknowledgment bit, end with a negative acknowledgment bit, and include a single bit transition between one or more positive acknowledgment bits and one or more negative acknowledgment bits, and
fourth codewords that start with a negative acknowledgment bit, end with a positive acknowledgment bit, and include a single bit transition between one or more positive acknowledgment bits and one or more negative acknowledgment bits.

25. The apparatus of claim 1, wherein the set of codewords includes:
a first codeword that starts with a positive acknowledgment bit, ends with a positive acknowledgment bit, and includes no bit transitions between one or more positive acknowledgment bits and one or more negative acknowledgment bits,
a second codeword that starts with a negative acknowledgment bit, ends with a negative acknowledgment bit, and includes no bit transitions between one or more positive acknowledgment bits and one or more negative acknowledgment bits,
third codewords that start with a positive acknowledgment bit, end with a negative acknowledgment bit, and include a single bit transition between one or more positive acknowledgment bits and one or more negative acknowledgment bits,
fourth codewords that start with a negative acknowledgment bit, end with a positive acknowledgment bit, and include a single bit transition between one or more positive acknowledgment bits and one or more negative acknowledgment bits, and
fifth codewords that start with a positive acknowledgment bit, end with a positive acknowledgment bit, and include two bit transitions between one or more positive acknowledgment bits and one or more negative acknowledgment bits.

26. The apparatus of claim 1, wherein the set of codewords includes:
a first codeword that starts with a positive acknowledgment bit, ends with a positive acknowledgment bit, and includes no bit transitions between one or more positive acknowledgment bits and one or more negative acknowledgment bits,
a second codeword that starts with a negative acknowledgment bit, ends with a negative acknowledgment bit, and includes no bit transitions between one or more positive acknowledgment bits and one or more negative acknowledgment bits,
third codewords that start with a positive acknowledgment bit, end with a negative acknowledgment bit, and include a single bit transition between one or more positive acknowledgment bits and one or more negative acknowledgment bits,
fourth codewords that start with a negative acknowledgment bit, end with a positive acknowledgment bit, and include a single bit transition between one or more positive acknowledgment bits and one or more negative acknowledgment bits, and
fifth codewords that start with a negative acknowledgment bit, end with a negative acknowledgment bit, and include two bit transitions between one or more positive acknowledgment bits and one or more negative acknowledgment bits.

27. The apparatus of claim 1, wherein the set of codewords includes:
a first codeword that starts with a positive acknowledgment bit, ends with a positive acknowledgment bit, and includes no bit transitions between one or more positive acknowledgment bits and one or more negative acknowledgment bits,
a second codeword that starts with a negative acknowledgment bit, ends with a negative acknowledgment bit, and includes no bit transitions between one or more positive acknowledgment bits and one or more negative acknowledgment bits,
third codewords that start with a positive acknowledgment bit, end with a negative acknowledgment bit, and include a single bit transition between one or more positive acknowledgment bits and one or more negative acknowledgment bits,
fourth codewords that starts with a negative acknowledgment bit, ends with a positive acknowledgment bit, and includes a single bit transition between one or more positive acknowledgment bits and one or more negative acknowledgment bits,
fifth codewords that start with a positive acknowledgment bit, end with a positive acknowledgment bit, and include two bit transitions between one or more positive acknowledgment bits and one or more negative acknowledgment bits, and
sixth codewords that start with a negative acknowledgment bit, end with a negative acknowledgment bit, and include two bit transitions between one or more positive acknowledgment bits and one or more negative acknowledgment bits.

28. A method of wireless communication performed at a user equipment (UE), comprising:
receiving one or more downlink communications; and
transmitting, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.

29. The method of claim 28, further comprising:
receiving an indication of the bit transition quantity threshold.

30. A method of wireless communication performed at a network node, comprising:
transmitting one or more downlink communications; and
receiving, responsive to the one or more downlink communications, hybrid automatic repeat request (HARQ) feedback that includes an index of a codeword of a set of codewords having respective quantities of bit transitions between one or more positive acknowledgment bits and one or more negative acknowledgment bits that satisfy a bit transition quantity threshold, the set of codewords being associated with respective distances to a HARQ feedback bit sequence, and the codeword being associated with a smallest distance of the respective distances.
